(19) United States
(12) Patent Application Publication
(10) Pub. No.: US 2021/0053631 A1
(43) Pub. Date: Feb. 25, 2021

(54) WATER ENERGY CLEANER FOR POOL

(71) Applicant: NingBo Poolstar Pool Products Co.,Ltd., Ningbo (CN)

(72) Inventor: Liang CHEN, Ningbo (CN)

(21) Appl. No.: 16/824,594

(22) Filed: Mar. 19, 2020

(30) Foreign Application Priority Data
Aug. 21, 2019 (CN) 201910774384.5

(51) Int. Cl. B62D 55/15; E04H 4/16; B60K 17/04; B62D 55/26; B60K 8/00; F16H 37/04

(52) U.S. Cl. CPC B62D 55/15; E04H 4/1672; B60K 17/04; F16H 2037/044; B60K 8/00; F16H 37/043; F16H 2702/00; B62D 55/26

(57) ABSTRACT

The present invention relates to a water energy cleaner for a pool, including a housing which is provided with a water inlet in the middle position of the bottom; a hydraulic motor used for providing power for the cleaner; travelling mechanisms used for travelling; a reversing mechanism used for changing a travelling direction; and a rotating swing joint mechanism used for connecting an external water outlet pipe and capable of swinging and rotating back and forth relative to the housing, The rotating swing joint mechanism of the present invention can swing and rotate back and forth relative to the travelling direction of the cleaner, which is beneficial for preventing the cleaner from being easily affected by a water pipe when the cleaner climbs up the wall of the pool for cleaning.

### CROSS-REFERENCE TO RELATED APPLICATIONS

This application claims the benefit of priority from Chinese Patent Application No. 201910774384.5, filed on Aug. 21, 2019. The content of the aforementioned application, including any intervening amendments thereto, is incorporated herein by reference in its entirety.

### TECHNICAL FIELD

The present invention relates to the technical field of pool cleaning, and particularly relates to a water energy cleaner for a pool.

### BACKGROUND OF THE PRESENT INVENTION

At present, the water energy cleaner for the pool is a cleaning device for the pool cleaning requirements. The water energy cleaner for the pool can climb autonomously on the bottom and the wall of the pool, repeatedly clean the dirt in the pool, filter the water in the pool, and keep the water quality of the pool in a normal range, thereby becoming an indispensable device for the normal maintenance of the pool.

However, a water outlet joint of the existing water energy cleaner for the pool is rigidly connected with the cleaner. When the cleaner travels to the pool wall for cleaning the wall cleaning and climbing, the cleaner will be affected by the water pipe. Because the water pipe also greatly bends, cleaner will be impacted to a certain degree. Meanwhile, the requirements for the flexibility of the water pipe are also high, which influences the wall climbing effect of the cleaner. When the cleaner travels to the corner position of the pool, the cleaner is also easy to jam, thereby reducing the cleaning efficiency. Meanwhile, a slippage phenomenon is easy to occur when a reversing mechanism is reversed, and the phenomenon of tooth jamming causes unstable reversing, increases damage and abrasion of the teeth and reduces the service life.

### SUMMARY OF THE PRESENT INVENTION

The purpose of the present invention is to provide a water energy cleaner for a pool, so as to solve the technical problems that: a water pipe impacts a cleaner due to rigid connection between a water outlet joint of the cleaner and the cleaner, is easy to block when travelling to a corner position of a pool and affects cleaning efficiency; meanwhile, a slippage phenomenon is easy to occur when a reversing mechanism is reversed, and the phenomenon of tooth jamming causes unstable reversing, increases damage and abrasion of the teeth and reduces the service life.

To achieve the above purpose, the present invention adopts the following technical solution: a water energy cleaner for a pool includes a housing which is provided with a water inlet in the middle position of the bottom, and further includes:

a hydraulic motor used for providing power for the cleaner;

travelling mechanisms used for travelling;

a reversing mechanism used for changing a travelling direction;

a rotating swing joint mechanism used for connecting an external water outlet pipe and capable of swinging and rotating back and forth relative to the housing,

wherein the hydraulic motor and the reversing mechanism are arranged in the housing; the hydraulic motor is arranged in the middle position in the housing and is communicated with the water inlet; the travelling mechanisms are symmetrically arranged on the left side and the right side of the housing; the rotating swing joint mechanism is arranged in the middle position on the top of the housing and is communicated with the hydraulic motor; one end of a motor output shaft of the hydraulic motor is provided with a first gear and the other end is provided with a second gear; the first gear is engaged with a first transmission mechanism; the first transmission mechanism is respectively engaged with a third transmission mechanism and a fourth transmission mechanism; the third transmission mechanism and the fourth transmission mechanism are respectively engaged with the travelling mechanisms on the left side and the right side of the housing; the second gear is engaged with the reversing mechanism through the second transmission mechanism; the reversing mechanism is connected with the first transmission mechanism; and the water inlet, the hydraulic motor and the rotating swing joint mechanism form a water circulation passage for a water stream to pass through.

Further, the rotating swing joint mechanism is composed of a swing head component, an upper cover plate and a lower fixing bracket, wherein the swing head component can swing back and forth and is installed between the upper cover plate and the lower fixing bracket; and the upper cover plate is fixedly connected with the lower fixing bracket.

Further, the swing head component is composed of a water outlet joint, a joint fixing bracket and a fixing collar, wherein a through hole is formed on the top of the joint fixing bracket; the water outlet joint penetrates through the through hole; the fixing collar is arranged at the through hole, is clamped with the joint fixing bracket, and is used for axially fixing the water outlet joint to the joint fixing bracket; and the water outlet joint can rotate relative to the joint fixing bracket.

Further, the first transmission mechanism includes a power transmission shaft and a transmission gear set, wherein the first gear and the transmission gear set are engaged with each other; one end of the power transmission shaft is engaged with the third transmission mechanism; the other end of the power transmission shaft is engaged with the fourth transmission mechanism; the power transmission shaft is fixedly connected with the transmission gear set; and the transmission gear set drives the power transmission shaft to rotate.

Further, one end of the power transmission shaft connected with the third transmission mechanism is a two-section gear structure.

Further, the second transmission mechanism is a reduction gear set; the third transmission mechanism includes a driving wheel, a third transmission driven wheel and an output shaft with a gear; a driving wheel gear is also arranged on one side of the driving wheel near the travelling mechanisms; the driving wheel gear and the driving wheel are of an integrated structure; the driving wheel gear is engaged with the third transmission driven wheel; the third transmission driven wheel is engaged with the output shaft; the output shaft is connected with the travelling mechanisms; and the fourth transmission mechanism has the same structure as the third transmission mechanism.

Further, the driving wheel is a rotating body having both a driving wheel internal gear and a driving wheel external gear, and the driving wheel internal gear and the driving wheel external gear are in coaxial positions; the power transmission shaft in the first transmission mechanism is arranged between the driving wheel internal gear and the driving wheel external gear, and is engaged with the driving wheel internal gear or the driving wheel external gear; when the power transmission shaft is engaged with the driving wheel internal gear, engaging rotation directions are the same direction; and when the power transmission shaft is engaged with the driving wheel external gear, the engaging rotation directions are opposite directions.

Further, the reversing mechanism includes a guide member and a movable member; the guide member is a cam having a larger radius part and a smaller radius part; the guide member is connected with the second transmission mechanism; the second transmission mechanism drives the guide member to rotate; the movable member includes a roller and a roller bracket; the roller is arranged at one end of the roller bracket near the guide member and is rotatably connected with the roller bracket; the roller bracket can slide back and forth; the roller bracket is sleeved on the power transmission shaft in the first transmission mechanism; the roller bracket drives the power transmission shaft to slide back and forth together; and the guide member is in contact with the roller.

Further, a plurality of rolling skirt wings are also symmetrically arranged at the bottom of the housing; the rolling skirt wings are rotatably connected with the housing; and the rolling skirt wings are used to increase suction around the water inlet at the bottom of the housing.

Further, the travelling mechanism is composed of a driven wheel, a driving wheel and a track; an inner surface and an outer surface of the track are provided with teeth; the teeth on the inner surface of the track are engaged with the driving wheel and the driven wheel; both sides of the track are convex and wrap the driving wheel and the driven wheel, or the driven wheel and the driving wheel are provided with grooves; the track is nested in the grooves of the driving wheel and the driven wheel; and the width of the track is smaller than the width of the grooves.

The present invention has the following beneficial effects: by adopting the movable rotating swing joint mechanism, the present invention can swing and rotate back and forth relative to the travelling direction of the cleaner, which is beneficial for preventing the cleaner from being easily affected by a water pipe when the cleaner climbs up the wall of the pool for cleaning, so that the water pipe does not impact the cleaner and requirements for the flexibility of the water pipe are also reduced. Since there is no problem of corner jamming caused by the impact of the water pipe, the cleaning efficiency is also improved. At the same time, one end of the power transmission shaft in the first transmission mechanism, which is connected with the third transmission mechanism, is a two-section gear structure. When engaged with the driving wheel internal gear or the driving wheel external gear, the power transmission shaft can make smooth transition, and is not easy to cause tooth hitting and slippage phenomena.

### BRIEF DESCRIPTION OF THE DRAWINGS

FIG. 1 is an exploded view of the present invention;

FIG. 2 is an exploded view of a rotating swing joint mechanism of the present invention;

FIG. 3 is an exploded view of a swing head component of the present invention;

FIG. 4 is an internal structural three-dimensional diagram of the present invention;

FIG. 5 is a three-dimensional diagram of a connection relationship of a first transmission mechanism of the present invention;

FIG. 6 is a three-dimensional diagram of engagement of a driving wheel and a power transmission shaft of the present invention;

FIG. 7 is a three-dimensional diagram of a third transmission mechanism of the present invention;

FIG. 8 is a three-dimensional diagram of a reversing mechanism of the present invention;

FIG. 9 is a schematic diagram of a swing direction of a swing head component of the present invention; and

FIG. 10 is a schematic diagram of a water stream direction of the present invention.

In the drawings: 1 housing; 2 hydraulic motor; 21 motor output shaft; 22 first gear; 23 second gear; 24 impeller component; 3 traveling mechanism; 31 driven wheel; 32 driving wheel; 33 track; 4 reversing mechanism; 41 guide member; 42 movable member; 421 roller; 422 roller bracket; 5 rotating swing joint mechanism; 51 swing head component; 511 water outlet joint; 512 joint fixing bracket; 5121 through hole; 513 fixing collar; 52 upper cover plate; 521 installing hole; 53 lower fixing bracket; 54 rotating shaft; 6 first transmission mechanism; 61 power transmission shaft; 611 two-section gear; 62 transmission gear set; 621 third gear; 622 fourth gear; 623 fifth gear; 7 second transmission mechanism; 8 third transmission mechanism; 81 driving wheel; 811 driving wheel gear; 812 driving wheel internal gear; 813 driving wheel external gear; 82 third transmission driven wheel; 83 output shaft; 9 fourth transmission mechanism; 10 water inlet; and 11 rolling skirt wing.

### DETAILED DESCRIPTION OF THE PRESENT INVENTION

In order to make the technical problems solved by the present invention, the technical solutions and the beneficial effects clearer, the present invention is further described in detail below in combination with the embodiments. It should be understood that the specific embodiments described herein are only used to explain the present invention and are not intended to limit the present invention.

It should be understood that in the description of the present invention, terms such as “left” and “right” indicate direction or position relationships shown based on the drawings, and are only intended to facilitate the description of the present invention rather than to require that the present invention must be constructed and operated in a specific direction, and therefore, shall not be understood as a limitation to the present invention.

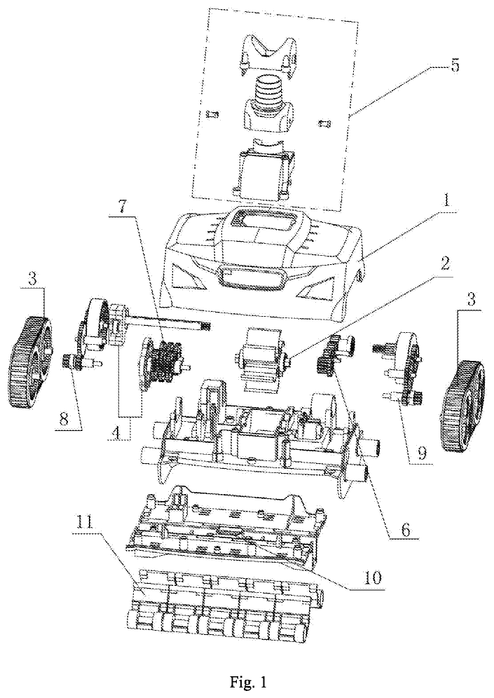

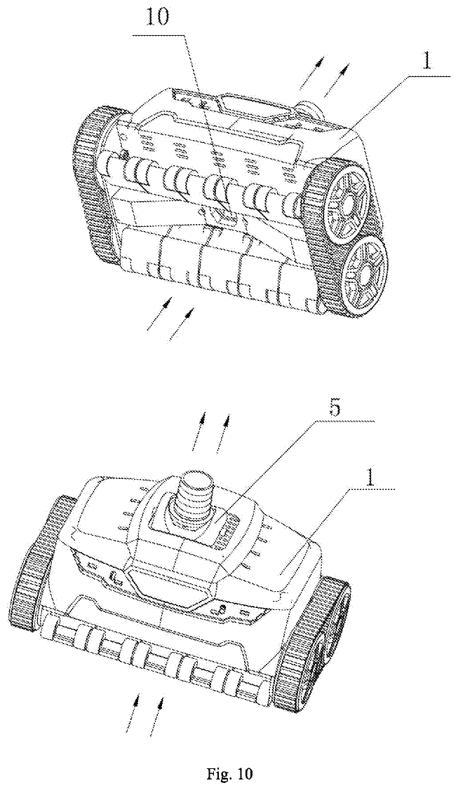

As an example, as shown in FIG. 1, the present invention provides a water energy cleaner for a pool, including a housing 1 which is provided with a water inlet 10 in the middle position of the bottom; a hydraulic motor 2 used for providing power for the cleaner; travelling mechanisms 3 used for travelling; a reversing mechanism 4 used for changing a travelling direction; a rotating swing joint mechanism 5 used for connecting an external water outlet pipe and capable of swinging and rotating back and forth relative to the housing 1,

wherein the hydraulic motor 2 and the reversing mechanism 4 are arranged in the housing 1; the hydraulic motor 2 is arranged in the middle position in the housing 1 and is communicated with the water inlet 10; the travelling mechanisms 3 are symmetrically arranged on the left side and the right side of the housing 1; the rotating swing joint mechanism 5 is arranged in the middle position on the top of the housing 1 and is communicated with the hydraulic motor 2; one end of a motor output shaft 21 of the hydraulic motor 2 is provided with a first gear 22 and the other end is provided with a second gear 23; the first gear 22 is engaged with a first transmission mechanism 6; the first transmission mechanism 6 is respectively engaged with a third transmission mechanism 8 and a fourth transmission mechanism 9; the third transmission mechanism 8 and the fourth transmission mechanism 9 are respectively engaged with the travelling mechanisms 3 on the left side and the right side of the housing 1; the second gear 23 is engaged with the reversing mechanism 4 through the second transmission mechanism 7; the reversing mechanism 4 is connected with the first transmission mechanism 6; by referring to FIG. 10, the water inlet 10, the hydraulic motor 2 and the rotating swing joint mechanism 5 form a water circulation passage for a water stream to pass through; and the hydraulic motor 2 is composed of an impeller component 24.

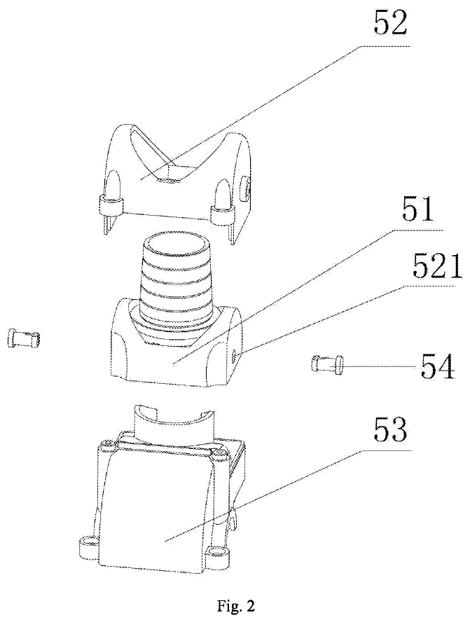

As shown in FIG. 2, the rotating swing joint mechanism 5 is composed of a swing head component 51, an upper cover plate 52 and a lower fixing bracket 53, wherein the swing head component 51 can swing back and forth and is installed between the upper cover plate 52 and the lower fixing bracket 53; and the upper cover plate 52 is fixedly connected with the lower fixing bracket 53. Specifically, the swing head component 51 is matched with installing holes 521 on both sides of the upper cover plate 52 through a rotating shaft 54 or a pin, and the swing head component 51 swings back and forth by using the installing holes 521 on both sides of the upper cover plate 52 as circle centers.

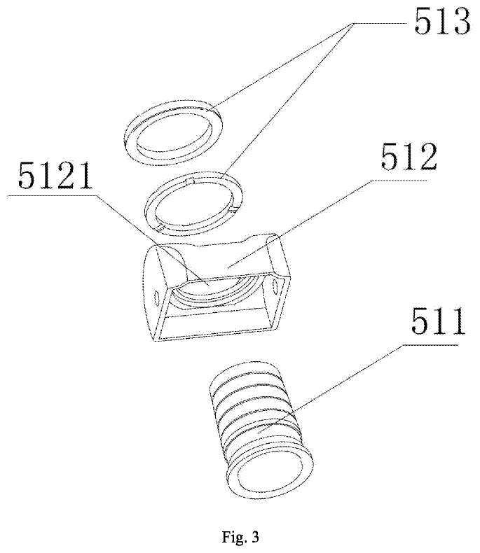

As shown in FIG. 3, the swing head component 51 is composed of a water outlet joint 511, a joint fixing bracket 512 and a fixing collar 513, wherein a through hole 5121 is formed on the top of the joint fixing bracket 512; the water outlet joint 511 penetrates through the through hole 5121; the fixing collar 513 is arranged at the through hole 5121, is clamped with the joint fixing bracket 512, and is used for axially fixing the water outlet joint 511 to the joint fixing bracket 512; and since the water outlet joint 511 is not fixed circumferentially, the water outlet joint 511 is only axially fixed to the joint fixing bracket 512 and the water outlet joint 511 can rotate relative to the joint fixing bracket 512.

As shown in FIG. 5, the first transmission mechanism 6 includes a power transmission shaft 61 and a transmission gear set 62, wherein the first gear 22 and the transmission gear set 62 are engaged with each other; one end of the power transmission shaft 61 is engaged with the third transmission mechanism 8; the other end of the power transmission shaft 61 is engaged with the fourth transmission mechanism 9; the power transmission shaft 61 is fixedly connected with the transmission gear set 62; and the transmission gear set 62 drives the power transmission shaft 61 to rotate. Specifically, the transmission gear set 62 includes a third gear 621, a fourth gear 622 and a fifth gear 623. The third gear 621 is fixedly arranged on the power transmission shaft 61. The fourth gear 622 and the fifth gear 623 are arranged between the first gear 22 and the third gear 621. The first gear 22 and the fourth gear 622 are engaged. The third gear 621 is engaged with the fifth gear 623, and the fourth gear 622 is engaged with the fifth gear 623, thereby transmitting power to the power transmission shaft 61.

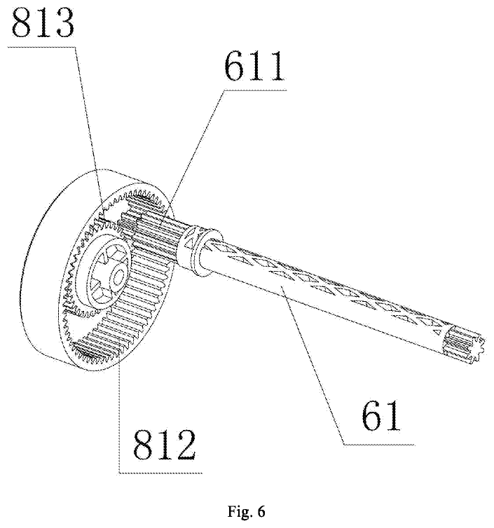

As shown in FIG. 6, one end of the power transmission shaft 61 connected with the third transmission mechanism 8 is a structure of a two-section gear 611. In this way, a transmission ratio when the power transmission shaft 61 is engaged with the driving wheel internal gear 812 and a transmission ratio when the power transmission shaft 61 is engaged with the driving wheel external gear 813 can be set close to each other. When the power transmission shaft 61 switches the engagement between the driving wheel external gear 813 and the driving wheel internal gear 812, a slippage phenomenon is not easy to occur.

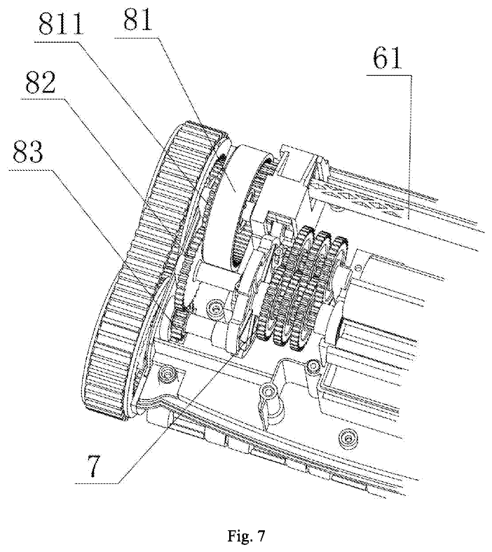

As shown in FIG. 7, the second transmission mechanism 7 is a reduction gear set; the third transmission mechanism 8 includes a driving wheel 81, a third transmission driven wheel 82 and an output shaft 83 with a gear; a driving wheel gear 811 is also arranged on one side of the driving wheel 81 near the travelling mechanisms 3; the driving wheel gear 811 and the driving wheel 81 are of an integrated structure; the driving wheel gear 811 is engaged with the third transmission driven wheel 82; the third transmission driven wheel 82 is engaged with the output shaft 83; the output shaft 83 is connected with the travelling mechanisms 3 to drive the travelling mechanisms 3 to travel; and the fourth transmission mechanism 9 and the third transmission mechanism 8 have the same structures and are symmetrically arranged. However, one end of the power transmission shaft 61 connected with the fourth transmission mechanism 9 is axially fixed, and can only be engaged with the driving wheel internal gear 812. The fourth transmission mechanism 9 can only rotate in one direction.

As shown in FIG. 6, the driving wheel 81 is a rotating body having both a driving wheel internal gear 812 and a driving wheel external gear 813, and the driving wheel internal gear 812 and the driving wheel external gear 813 are in coaxial positions; the power transmission shaft 61 in the first transmission mechanism 6 is arranged between the driving wheel internal gear 812 and the driving wheel external gear 813, and is engaged with the driving wheel internal gear 812 or the driving wheel external gear 813; when the power transmission shaft 61 is engaged with the driving wheel internal gear 812, engaging rotation directions are the same direction; and when the power transmission shaft 61 is engaged with the driving wheel external gear 813, the engaging rotation directions are opposite directions.

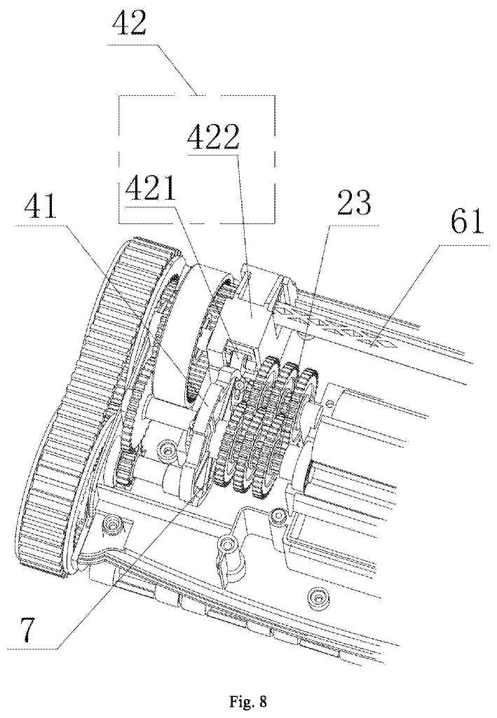

As shown in FIG. 8, the reversing mechanism 4 includes a guide member 41 and a movable member 42; the guide member 41 is a cam having a larger radius part and a smaller radius part; the guide member 41 is connected with the second transmission mechanism 7; the second transmission mechanism 7 drives the guide member 41 to rotate; the movable member 42 includes a roller 421 and a roller bracket 422; the roller 42 is arranged at one end of the roller bracket 422 near the guide member 41 and is rotatably connected with the roller bracket 422; the roller bracket 422 can slide back and forth; the roller bracket 422 is sleeved on the power transmission shaft 61 in the first transmission mechanism 6; the roller bracket 422 drives the power transmission shaft 61 to slide back and forth together; and the guide member 41 is in contact with the roller 421.

As shown in FIG. 1, a plurality of rolling skirt wings 11 are also symmetrically arranged at the bottom of the housing 1; the rolling skirt wings 11 are rotatably connected with the housing 1; and the rolling skirt wings 11 are used to increase suction around the water inlet at the bottom of the housing 1.

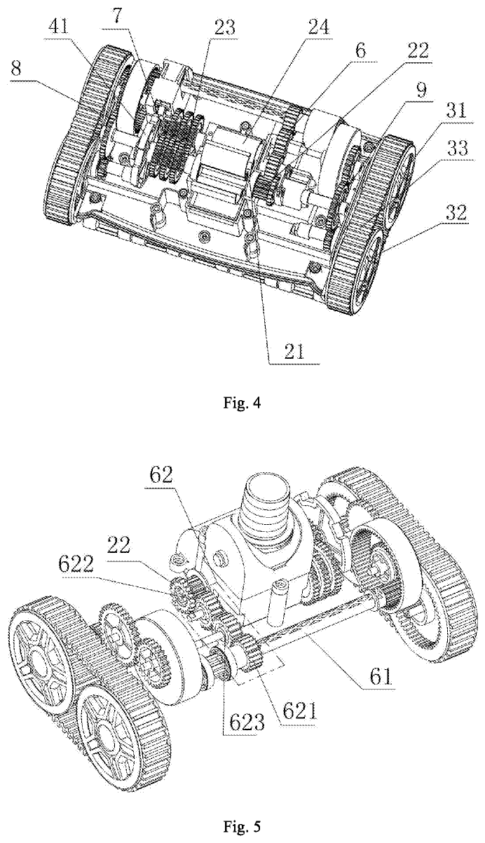

As shown in FIG. 4, the travelling mechanism 3 is composed of a driven wheel 31, a driving wheel 32 and a track 33; an inner surface and an outer surface of the track 33 are provided with teeth; the teeth on the inner surface of the track 33 are engaged with the driving wheel 31 and the driven wheel 32; the outer surface of the track 33 is also provided with a full circle of reinforcing belt; the reinforcing belt is perpendicular to the direction of the teeth on the outer surface of the track 33; both sides of the track 33 are convex and wrap the driving wheel 32 and the driven wheel 31, or the driven wheel 31 and the driving wheel 32 are provided with grooves; the track 33 is nested in the grooves of the driving wheel 32 and the driven wheel 31; and the width of the track 33 is smaller than the width of the grooves.

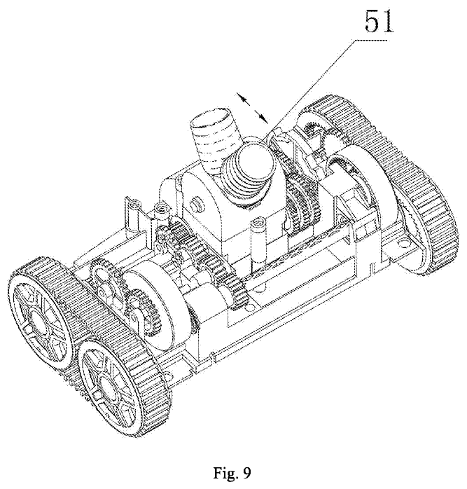

As shown in FIG. 2, FIG. 3 and FIG. 9, the swing head component 51 of the rotating swing joint mechanism 5 can swing back and forth along the upper cover plate 52, and the water outlet joint 511 can rotate. When the cleaner travels to the wall of the pool, the swing head component 51 of the rotating swing joint mechanism 5 can swing the direction to adapt to the connection with a water pipe, thereby reducing a torsional force on the cleaner due to the buoyancy of the water pipe, so that the cleaner is easy to climb up the wall of the pool, so as to increase the cleaning range of the pool.

The working principle of the present invention is as follows: water is sucked in from the water inlet 10 at the bottom of the cleaner housing 1, is rotated by the impeller component 24, and is discharged from the water outlet joint 511. The water outlet joint 511 is connected with the water pipe; the water pipe is connected with a water pump; the impeller component 24 drives the motor output shaft 21; the first gear 22 at one end of the motor output shaft 21 drives the first transmission mechanism 6; and the second gear 23 at the other end drives the second transmission mechanism 7. The first transmission mechanism 6 transmits the power to the third transmission mechanism 8 and the fourth transmission mechanism 9 through the power transmission shaft 61; the third transmission mechanism 8 and the fourth transmission mechanism 9 drive the travelling mechanisms 3 on the left side and the right side of the housing 1; and the second transmission mechanism 7 drives the reversing mechanism 4. Specifically, the second gear 23 drives the second transmission mechanism 7 to rotate. The second transmission mechanism 7 drives the guide member 41 engaged with the second transmission mechanism 7 to rotate together, and the guide member 41 is in contact with the roller 421. The roller 421 swings under the guidance of the guide member 41. The roller 421 drives the roller bracket 422 to slide back and forth. The roller bracket 422 drives the power transmission shaft 51 to slide back and forth together. Since one end of the power transmission shaft 61 engaged with the fourth transmission mechanism 9 is a fixed end, and one end of the power transmission shaft 61 engaged with the third transmission mechanism 8 is a movable end, only one end engaged with the third transmission mechanism 8 can slide back and forth to engage with the driving wheel internal gear 812 or the driving wheel external gear 813. When the power transmission shaft 61 is engaged with the driving wheel internal gear 812, engaging rotation directions are the same direction; and when the power transmission shaft 61 is engaged with the driving wheel external gear 813, the engaging rotation directions are opposite directions. That is, when the rotation directions of the third transmission mechanism 8 and the fourth transmission mechanism 9 are consistent, the rotation directions are advancing directions; and when the rotation directions of the third transmission mechanism 8 and the fourth transmission mechanism 9 are opposite to each other, the rotation directions are turning directions, thereby realizing the reversing.

The above only describes preferred embodiments of the present invention and is not intended to limit the present invention. Therefore, any modification, equivalent replacement and improvement made using the description and drawings of the present invention shall be included in the protection scope of the present invention.

What is claimed is:

1. A water energy cleaner for a pool, comprising a housing which is provided with a water inlet in the middle position of the bottom, and further comprising:
a hydraulic motor used for providing power for the cleaner;
travelling mechanisms used for travelling;
a reversing mechanism used for changing a travelling direction;
a rotating swing joint mechanism used for connecting an external water outlet pipe and capable of swinging and rotating back and forth relative to the housing,
wherein the hydraulic motor and the reversing mechanism are arranged in the housing; the hydraulic motor is arranged in the middle position in the housing and is communicated with the water inlet; the travelling mechanisms are symmetrically arranged on the left side and the right side of the housing; the rotating swing joint mechanism is arranged in the middle position on the top of the housing and is communicated with the hydraulic motor; one end of a motor output shaft of the hydraulic motor is provided with a first gear and the other end is provided with a second gear; the first gear is engaged with a first transmission mechanism; the first transmission mechanism is respectively engaged with a third transmission mechanism and a fourth transmission mechanism; the third transmission mechanism and the fourth transmission mechanism are respectively engaged with the travelling mechanisms on the left side and the right side of the housing; the second gear is engaged with the reversing mechanism through the second transmission mechanism; the reversing mechanism is connected with the first transmission mechanism; and the water inlet, the hydraulic motor and the rotating swing joint mechanism form a water circulation passage for a water stream to pass through.

2. The water energy cleaner for the pool according to claim 1, wherein the rotating swing joint mechanism is composed of a swing head component, an upper cover plate and a lower fixing bracket, wherein the swing head component can swing back and forth and is installed between the upper cover plate and the lower fixing bracket; and the upper cover plate is fixedly connected with the lower fixing bracket.

3. The water energy cleaner for the pool according to claim 2, wherein the swing head component is composed of a water outlet joint, a joint fixing bracket and a fixing collar, wherein a through hole is formed on the top of the joint fixing bracket; the water outlet joint penetrates through the through hole; the fixing collar is arranged at the through hole, is clamped with the joint fixing bracket, and is used for axially fixing the water outlet joint to the joint fixing bracket; and the water outlet joint can rotate relative to the joint fixing bracket.

4. The water energy cleaner for the pool according to claim 1, wherein the first transmission mechanism comprises a power transmission shaft and a transmission gear set, wherein the first gear and the transmission gear set are engaged with each other; one end of the power transmission shaft is engaged with the third transmission mechanism; the other end of the power transmission shaft is engaged with the fourth transmission mechanism; the power transmission shaft is fixedly connected with the transmission gear set; and the transmission gear set drives the power transmission shaft to rotate.

5. The water energy cleaner for the pool according to claim 4, wherein one end of the power transmission shaft connected with the third transmission mechanism is a two-section gear structure.

6. The water energy cleaner for the pool according to claim 1, wherein the second transmission mechanism is a reduction gear set; the third transmission mechanism comprises a driving wheel, a third transmission driven wheel and an output shaft with a gear; a driving wheel gear is also arranged on one side of the driving wheel near the travelling mechanisms; the driving wheel gear and the driving wheel are of an integrated structure; the driving wheel gear is engaged with the third transmission driven wheel; the third transmission driven wheel is engaged with the output shaft; the output shaft is connected with the travelling mechanisms; and the fourth transmission mechanism has the same structure as the third transmission mechanism.

7. The water energy cleaner for the pool according to claim 6, wherein the driving wheel is a rotating body having both a driving wheel internal gear and a driving wheel external gear, and the driving wheel internal gear and the driving wheel external gear are in coaxial positions; the power transmission shaft in the first transmission mechanism is arranged between the driving wheel internal gear and the driving wheel external gear, and is engaged with the driving wheel internal gear or the driving wheel external gear; when the power transmission shaft is engaged with the driving wheel internal gear, engaging rotation directions are the same direction; and when the power transmission shaft is engaged with the driving wheel external gear, the engaging rotation directions are opposite directions.

8. The water energy cleaner for the pool according to claim 1, wherein the reversing mechanism comprises a guide member and a movable member; the guide member is a cam having a larger radius part and a smaller radius part; the guide member is connected with the second transmission mechanism; the second transmission mechanism drives the guide member to rotate; the movable member comprises a roller and a roller bracket; the roller is arranged at one end of the roller bracket near the guide member and is rotatably connected with the roller bracket; the roller bracket can slide back and forth; the roller bracket is sleeved on the power transmission shaft in the first transmission mechanism; the roller bracket drives the power transmission shaft to slide back and forth together; and the guide member is in contact with the roller.

9. The water energy cleaner for the pool according to claim 1, wherein a plurality of rolling skirt wings are also symmetrically arranged at the bottom of the housing; the rolling skirt wings are rotatably connected with the housing; and the rolling skirt wings are used to increase suction around the water inlet at the bottom of the housing.

10. The water energy cleaner for the pool according to claim 1, wherein the travelling mechanism is composed of a driven wheel, a driving wheel and a track; an inner surface and an outer surface of the track are provided with teeth; the teeth on the inner surface of the track are engaged with the driving wheel and the driven wheel; both sides of the track are convex and wrap the driving wheel and the driven wheel, or the driven wheel and the driving wheel are provided with grooves; the track is nested in the grooves of the driving wheel and the driven wheel; and the width of the track is smaller than the width of the grooves.
